(19) United States
(12) Patent Application Publication
(10) Pub. No.: US 2006/0130335 A1
(43) Pub. Date: Jun. 22, 2006

(54) Electrical hair remover

(76) Inventor: Chi Ming Suen, Hong Kong (CN)

Correspondence Address: LEE W. TOWER, 19 SADDLE ROAD, RANCHO PALOS VERDES, CA, 90275, US

(21) Appl. No.: 11/016,471

(22) Filed: Dec. 18, 2004

(51) Int. Cl. B26B 19/00

(52) U.S. Cl. 30/34.05

(57) ABSTRACT

An electrical device removes body and facial hair and dead skin cells by buffing and abrading by rotating motion. The electrical hair removing device has one, two or three abrasive surfaces for pressing against hairy skin to exfoliate the skin and abrade the hair by automatic and continual electronically controlled rotational movement in the same direction. Hooks and loops removably attach each abrasive surface to a circular base driven in rotation. The two or three abrasive surfaces can be controlled to rotate at different speeds. The two or three abrasive surfaces can also be controlled to rotate in alternating directions and at different speeds.

### BACKGROUND OF THE INVENTION

1. Field of the Invention

This invention relates to a device for removing body and facial hair. More particularly, it relates to a hair remover for removing hair by buffing and abrasion, while simultaneously proving beneficial effects to the skin.

2. Background Information

The common solution to remove unwanted hair is by using a shaving or cutting device, which can cause irritability and dryness to the skin. The growth rate of the cut hairs can be erratic and the skin can become more sensitive due to cuts and scrapes. In addition, shaving can leave rough stubble.

Epilation devices remove hair by pulling it out. One technique is to apply mastic to the skin and then to allow the mastic to dry. When the mastic is removed the hairs attached to the mastic are pulled out, which is a painful process. Another technique is to merely pull out the hair. In either case the hair must be long enough in length before it can be grasped for removal by mastic or pulling. Therefore, one must wait for the hair to grow.

Electrolysis has been used for removing hair by applying an electric current to the hair follicles to kill the hair itself. This method requires professional assistance. Since each hair must be removed individually, this approach becomes tedious and time consuming.

U.S. Pat. No. 2,714,788 to Giovanna discloses an electrical apparatus for removing hair by electrically rotating one abrasive disk against the skin. Giovanna discloses the rotation of the disk to be alternating clockwise and then counterclockwise and describes the advantage of alternating rotation. In Giovanna the one large disk is difficult to control and the alternating clockwise and counterclockwise movements are accomplished solely by gear mechanisms, which are prone to wear out quickly, and are expensive to manufacture.

U.S. Pat. No. 5,084,046 to Isack discloses another abrasive device that has a ring head with an abrasive surface that rotates eccentrically around a nonabrasive ring.

U.S. Pat. No. 5,377,699 to Varnum discloses a driveable member having a rotating column covered with an abrasive surface for removal of hair. A protective screen to protect the skin covers the abrasive surface.

The above devices have limited effectiveness and are difficult to control in addition to being expensive to manufacture.

Accordingly, there is a need in the art for a hair remover that is less painful, can be used when hair growth is short, can be used without professional assistance, and is more cost effective and easier to control.

### SUMMARY OF THE INVENTION

An electrical device removes body and facial hair and dead skin cells by buffing and abrading by rotating motion. In one embodiment an electrical hair removing device has an abrasive surface for pressing against hairy skin to exfoliate the skin and abrade the hair by automatic and continual electronically controlled rotational movement in the same direction. The abrasive surface is removably attached by hooks and loops to a circular base driven in rotation. The rotational movement can also be controlled to be in alternating directions.

In another embodiment an electrical hair removing device has two coplanar and concentrically disposed abrasive surfaces rotating about a single rotational axis for pressing against hairy skin to exfoliate the skin and abrade the hair by automatic and continual electronically controlled rotational movement in the same direction. The two abrasive surfaces can be controlled to rotate at different speeds. The two abrasive surfaces can also be controlled to rotate in alternating directions and at different speeds. The two abrasive surfaces are removably attached by hooks and loops to bases that are concentric to one another.

In yet another embodiment the electrical hair removing device has three coplanar abrasive surfaces rotating on three different axes located at the vertices of a virtual triangle for pressing against hairy skin to exfoliate the skin and abrade the hair by automatic and continual electronically controlled rotational movement in the same direction. The three abrasive surfaces can be controlled to rotate at different speeds. Each of the three abrasive surfaces can also be rotated in alternating directions and at different speeds.

The repeated rotation of the buffing and abrasive surfaces causes flexure of the hair strands near to their roots and below the surface of the skin, while simultaneously reducing the thickness of the hair shaft. The hair shafts become weakened and break off. Visibility is reduced, and the hair root is left intact with this repeated process. The removal of the hair shaft to below the skin surface, by exfoliating the skin, additionally results in a smoother skin surface.

The buffing has a beneficial effect on the skin itself, removing dead skin cells, smoothing roughness of the skin and reducing cosmetic flaws, such as rosatia and cellulite, by continuous stimulation. After continuous buffing and exfoliating, hair growth becomes less vigorous. Buffing actually removes tiny hair shafts at the root level, consequently causing no future growth of the hair follicle. By comparison, traditional blade shaving provides little or no stimulation and actually damages the skin.

Other attendant features of this invention will be more readily appreciated as the same becomes better understood by reference to the following detailed descriptions and considered in connection with the accompanying drawings in which like reference symbols designate like parts throughout the figures.

### BRIEF DESCRIPTION OF THE DRAWINGS

FIG. 1 is a perspective view of an electric hair remover showing a power cord pluggable into the electric hair remover in accordance with the present invention.

FIG. 2 is a side view of the electric hair remover showing an abrasive pad removably attached by hooks and loops to a circular base in accordance with the present invention.

FIG. 3 is an enlargement of the circled area of FIG. 2 showing the abrasive pad removably attached by hooks and loops to a circular base in accordance with the present invention.

FIG. 4A is a bottom perspective view of the electric hair remover showing the abrasive pad attached to the circular base of FIG. 3 in accordance with the present invention.

FIG. 4B is a diagram showing the direction of rotation of the abrasive pad of FIG. 4A when the electric hair remover power is turned on in accordance with the present invention.

FIG. 4C is a diagram showing alternating directions of rotation of the abrasive pad of FIG. 4A when the electric hair remover power is turned on in accordance with the present invention.

FIG. 5 is a diagram showing the abrasive pad of FIG. 4A partially removed from the circular base in accordance with the present invention.

FIG. 6A is a bottom perspective view of a hair remover having an inner circular abrasive pad removably attached to an inner circular base and another outer ring abrasive pad, the outer ring abrasive pad surrounding and concentric with the inner circular abrasive pad and removably attached to an outer ring base surrounding and concentric to the inner circular base in accordance with the present invention.

FIG. 6B is a diagram showing the direction of rotation of the inner circular abrasive pad and the outer ring abrasive pad of FIG. 6A when the electric hair remover power is turned on in accordance with the present invention.

FIG. 6C is a diagram showing altering directions of rotation of the inner circular abrasive pad and the outer ring abrasive pad of FIG. 6A when the electric hair remover power is turned on in accordance with the present invention.

FIG. 7 is a diagram showing the inner circular abrasive pad partially removed from the inner circular base in accordance with the present invention.

FIG. 8 is a diagram showing the outer ring abrasive pad partially removed from the outer ring base in accordance with the present invention.

FIG. 9A is a bottom perspective view of a hair remover having three circular abrasive pads removably attached to three circular bases in accordance with the present invention.

FIG. 9B is a diagram showing the direction of rotation of the circular abrasive pads of FIG. 9A when the electric hair remover power is turned on in accordance with the present invention.

FIG. 9C is a diagram showing alternating directions of rotation of the circular abrasive pads of FIG. 9A when the electric hair remover power is turned on in accordance with the present invention.

FIG. 10 is a diagram showing one of the three circular abrasive pads of FIG. 9A partially removed from one of the three circular bases in accordance with the present invention.

FIG. 11 is a diagram of the electric motor and control and the gear box of the hair remover of FIGS. 4A, 4B, 4C, and 5 in accordance with the present invention.

FIG. 12 is a diagram of the electric motor and control and the gear box of the hair remover of FIGS. 6A, 6B, 6C, 7 and 8 in accordance with the present invention.

FIG. 13 is a diagram of the electric motor and control and the gear box of the hair remover of FIGS. 9A, 9B, 9C, and 10 in accordance with the present invention.

### DETAILED DESCRIPTION OF THE PREFERRED EMBODIMENT

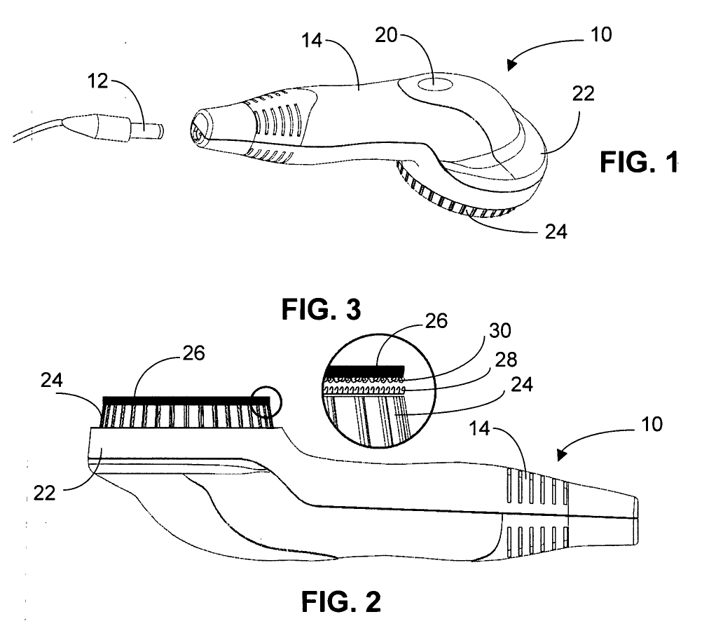

Referring now to the drawings, FIG. 1 shows a perspective view of an electric hair remover 10 showing a power plug 12, which is plugged in to provide power to the electric hair remover 10. An ac-dc adapter (not shown) converts AC power to DC power for the power plug 12. The handle 14 of the electric hair remover 10 contains a electric motor 16, which drives a gear box 18, as shown in FIG. 11. The handle 14 also has an On/Off switch 20, which turns power on and off to the electric motor 16. The head 22 of the electric hair remover 10 has a circular shape and has a circular base 24, which rotates when the on/off switch 20 is turned on. FIG. 2 is a side view of the electric hair remover 10 showing an abrasive pad 26 removably attached by hooks 28 and loops 30 to the circular base 24, as shown in FIG. 3, which is an enlargement of the circled portion of FIG. 2. In FIG. 3 the loops 30 are shown on the abrasive pad 26 and the hooks 28 are shown on the circular base 24, but the hooks could be located on the abrasive pad and the loops on the circular base, as desired. The abrasive pad has fine grit on its surface.

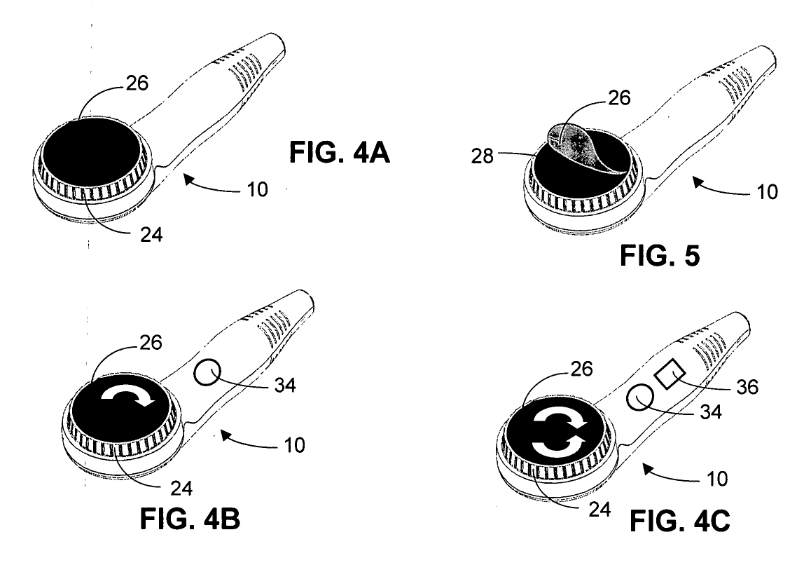

FIG. 4A is a bottom perspective view of the electric hair remover 10 showing the abrasive pad 26 attached to the circular base 24. FIG. 4B shows the direction of rotation of the abrasive pad 26 when the on/off switch 20 is turned on. The direction of rotation is continual in the same direction and the speed of rotation can be controlled using speed control 32, which controls the speed of the electric motor 16, as shown in FIG. 11. The electric motor rotates the circular base 24 via the gearbox 18.

FIG. 4C is a diagram showing the abrasive pad 26 rotating in alternating directions. Switch 36 is provided to select between continual rotation in one direction or rotation in alternating directions. Alternating rotation helps lift the hair to allow it to be easier to abrade. The electric motor 16 rotations are electronically controlled and can be selected to rotate in the alternating directions via switch 36 shown in FIG. 11.

FIG. 5 is a diagram showing the abrasive pad 26 partially removed from the circular base 28.

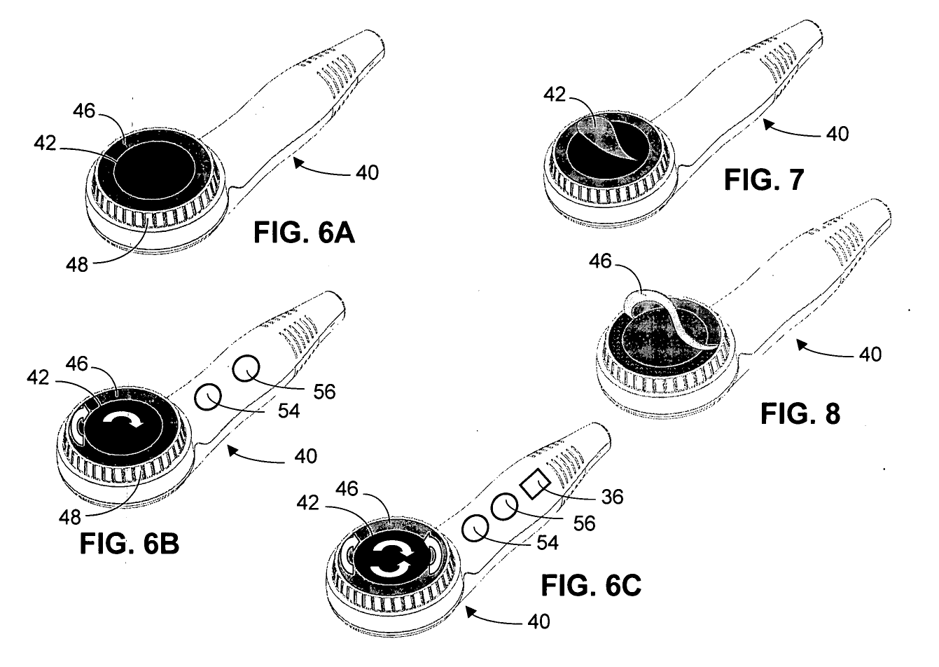

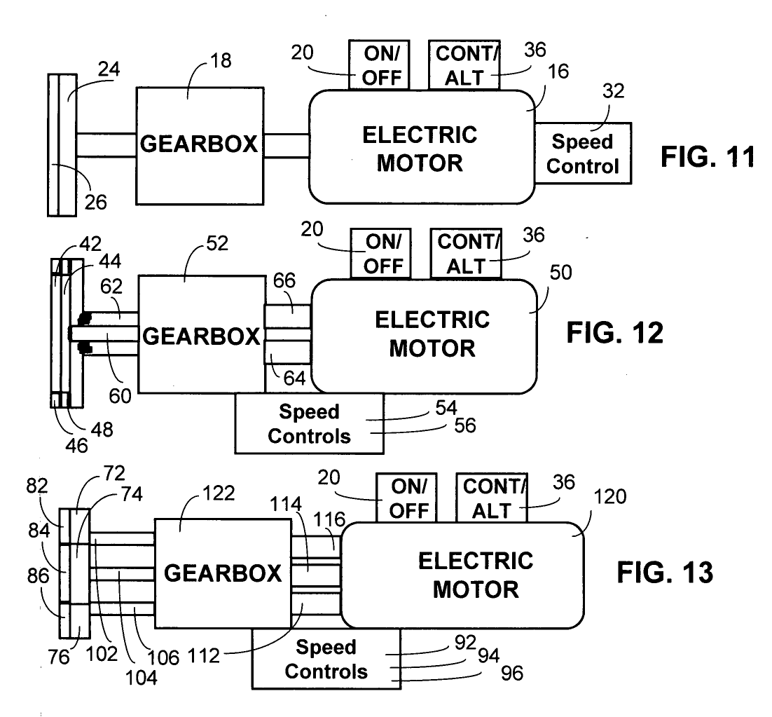

FIG. 6A is a bottom perspective view of an electric hair remover 40 having an inner circular abrasive pad 42 removably attached to an inner circular base 44, as shown in FIG. 12. FIG. 6B also shows another outer ring abrasive pad 46 surrounding and concentric with the inner circular abrasive pad 42 and removably attached to an outer ring base 48, which is surrounding and concentric to the inner circular base 44.

When the on/off switch 20 is turned on, the direction of rotation of the inner circular abrasive pad 42 and the outer ring abrasive pad 46 is shown in FIG. 6B. The rotation of the inner circular base 44 and the outer ring base 48 are driven from gearbox 52 via shafts 60 and 62, respectively, as shown in FIG. 12.

To further improve the operation of the electric hair remover, the speed of rotation of the inner circular base 44 and the outer ring base 48 can be controlled via speed controls 54 and 56, respectively. Varying the speed of rotations can be implemented in a number of ways. The most common configuration is to switch between gear ratios in the gearbox 52 to accomplish different speeds. Another method is to provide two electric motors 50 with separate drive shafts 64 and 66, which can be controlled to spin at different rates. The drive shafts via gearbox 52 drive the inner circular base 44 and the outer ring base 48, respectively. This latter method has the advantage of finer speed control because the electric motors 50 are electronically controlled.

FIG. 6C is a diagram showing altering directions of rotation of the inner circular abrasive pad 42 and the outer ring abrasive pad 46. Switch 36 is provided to select between continual rotation in one direction or rotation in alternating directions, which is implemented by electronic control of the electric motor 50, which can be quickly reversed. As described above, alternating rotation helps lift the hair to allow it to be easier to abrade. As in the continual rotation in one direction, the speed of alternating rotation of the inner circular base 44 and the outer ring base 48 can be controlled via speed controls 54 and 56, respectively. Again, controlling the speed of the alternating rotations can be implemented by either switching between gear ratios in the gearbox 52 or by providing two electric motors 50 with two separate drive shafts 64 and 66, which via gearbox 52, drive the inner circular base 44 and the outer ring base 48, respectively. This latter method has the advantage of finer speed control because the electric motors 50 are electronically controlled.

FIG. 7 is a diagram showing the inner circular abrasive pad 42 partially removed from the inner circular base. Likewise, FIG. 8 is a diagram showing the outer ring abrasive pad 46 partially removed from the outer ring base 48.

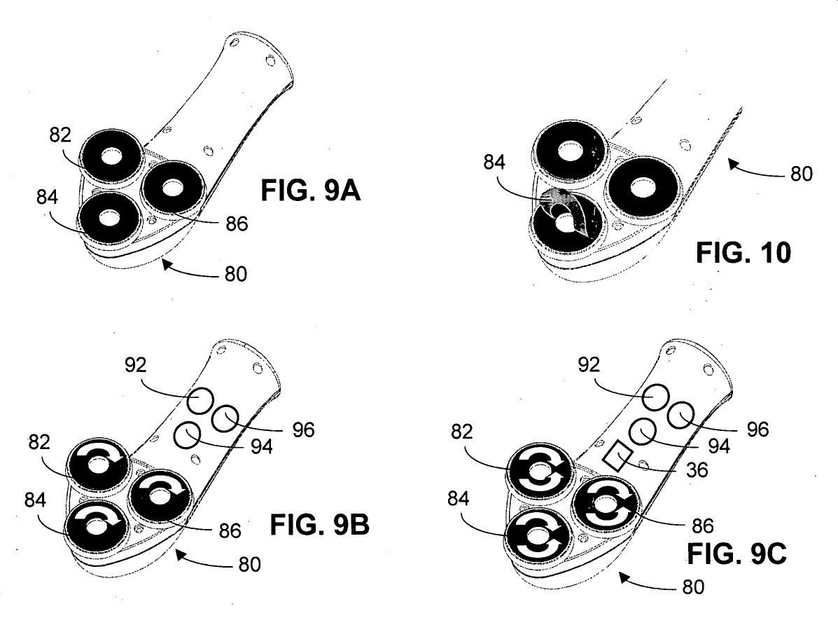

FIG. 9A is a bottom perspective view of an electric hair remover 40 having three circular abrasive pads 82, 84, and 86 removably attached to three circular bases 72, 74, and 76, as shown in FIG. 13. When the on/off switch 20 is turned on, the direction of rotation of the three circular abrasive pads 82, 84, and 86 is shown in FIG. 9B. The rotation of the three circular bases 72, 74, and 76 are driven from gearbox 122 via shafts 102, 104 and 106, respectively, as shown in FIG. 13.

The speed of rotation of the three circular bases 72, 74, and 76 can be controlled via speed controls 92, 94 and 96, respectively. Varying the speed of rotations can be implemented in a number of ways. The most common method of varying the speed of rotations is to switch between gear ratios in the gearbox 122 to accomplish different speeds. Another method is to provide three electric motors 120 with three separate drive shafts 112, 114 and 116, which can spin at different rates and which via gearbox 122 drive the three circular bases 72, 74, and 76, respectively. This method has the advantage of finer electronic speed control.

FIG. 9C is a diagram showing alternating directions of rotation of the three circular abrasive pads 82, 84, and 86. Switch 36 is provided to select between continual rotation in one direction or rotation in alternating directions, which is implemented by electronic control of the electric motor 120, which can be quickly reversed. As described above, alternating rotation helps lift the hair to allow it to be easier to abrade. As in the continual rotation in one direction, the speed of alternating rotation of the three circular abrasive pads 82, 84, and 86 can be controlled via speed controls 92, 94 and 96, respectively. Again, varying the speed of the alternating rotations can be implemented by either switching between gear ratios in the gearbox 122 or by providing three electric motors 120 with three separate drive shafts 112, 114, and 116, which can be controlled to spin at different rates. This has the advantage of finer electronic speed control by controlling electric motor 120.

FIG. 10 is a diagram showing circular pad 84 partially removed from circular base 74.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope of the present invention and additional fields in which the present invention would be of significant utility.

It is therefore intended by the appended claims to cover any and all such applications, modifications and embodiments within the scope of the present invention.

What is claimed is:

1. An electrical hair removing device comprising an:
abrasive surface for pressing against hairy skin to exfoliate the skin and abrade the hair by automatic and continual electronically controlled rotational movement in the same direction.

2. The hair removing device of claim 2 wherein the abrasive surface is removably attached by hooks and loops to a circular base driven in rotation.

3. The hair removing device of claim 1 wherein speed of the rotational movement is controllable.

4. The hair removing device of claim 1 wherein:
said movement is rotational and in alternating directions; and
the abrasive surface is removably attached by hooks and loops to a circular base driven in rotation.

5. The hair removing device of claim 4 wherein speed of the alternating rotational movement is controllable.

6. An electrical hair removing device comprising two coplanar and concentrically disposed abrasive surfaces rotating about a single rotational axis for pressing against hairy skin to exfoliate the skin and abrade the hair by automatic and continual electronically controlled rotational movement in the same direction.

7. The hair removing device of claim 6 wherein said two abrasive surfaces rotate at different speeds.

8. The hair removing device of claim 7 wherein said different speeds for each abrasive surface are controllable.

9. The hair removing device of claim 6 wherein:
each of said two abrasive surfaces rotate in alternating directions; and
each of said two abrasive surfaces rotate in alternating directions at different speeds.

10. The hair removing device of claim 9 wherein said different speeds for each abrasive surface are controllable.

11. The hair removing device of claim 6 wherein:
one of said two abrasive surfaces is removably attached by hooks and loops to a first base;
the second of said two abrasive surfaces is removably attached by hooks and loops to a second base concentrically disposed to the first base; and
the first and second base are each driven to rotate about a single rotational axis.

12. An electrical hair removing device comprising three coplanar abrasive surfaces rotating on three different axes located at the vertices of a virtual triangle for pressing against hairy skin to exfoliate the skin and abrade the hair by automatic and continual electronically controlled rotational movement in the same direction.

13. The hair removing device of claim 12 wherein said three abrasive surfaces rotate at different speeds.

14. The hair removing device of claim 13 wherein said different speeds for the three abrasive surfaces are controllable.

15. The hair removing device of claim 12 wherein each of said three abrasive surfaces rotate in alternating directions.

16. The hair removing device of claim 15 wherein each of said three abrasive surfaces rotate in alternating directions at different speeds.

17. The hair removing device of claim 16 wherein said different speeds for the three abrasive surfaces are controllable.

18. The hair removing device of claim 12 wherein each of said three abrasive surfaces is removably attached by hooks and loops to a base driven to rotate about a single rotational axis.
